(19) United States
(12) Patent Application Publication
(10) Pub. No.: US 2003/0126159 A1
(43) Pub. Date: Jul. 3, 2003

(54) Method and system for rollback of software system upgrade

(76) Inventor: John I. Nwafor, Dallas, TX (US)

Correspondence Address: JENKENS & GILCHRIST, P.C., 3200 Fountain Place, 1445 Ross Avenue, Dallas, TX, 75202-2799, US

(21) Appl. No.: 10/225,740

(22) Filed: Aug. 22, 2002

Related U.S. Application Data
(60) Provisional application No. 60/344,413, filed on Dec. 28, 2001.

(51) Int. Cl. G06F 12/00

(52) U.S. Cl. 707/200

(57) ABSTRACT

Method and system for rollback of an Enterprise Resource Planning (ERP) system to a previous state after one or more functional modifications have been implemented in the ERP system. In the method, functional modification data is received, previous version data of the functional modification data is stored, the functional modification data is implemented in the ERP system, rollback command data is received, and the previous version data of the functional modification data is implemented in the ERP system in place of the functional modification data. The invention permits an ERP system to be quickly restored to proper operation after a functional modification interferes with proper operation of the ERP system.

This application claims the benefit of co-pending U.S. Provisional Patent Application Serial No. 60/344,143 filed on Dec. 28, 2001.

### BACKGROUND OF THE INVENTION

1. Field of the Invention

The present invention relates generally to Enterprise Resource Planning (ERP) systems and, more particularly, but not by way of limitation, to a method and system for rollback of an Enterprise Resource Planning (ERP) system to a previous state after one or more functional modifications have been implemented in the system.

2. Description of Related Art

It is a common practice to periodically make modifications to functions of an ERP system in order to provide the system with new capabilities, to improve existing capabilities or to generally upgrade the system. It sometimes occurs, however, that such modifications can have a deleterious effect on the operation of the system. For example, it is possible that a change to one or more functional processes of an ERP system can be inconsistent with other functions that are performed by the system. In an SAP R/3 type system, for example, when a transport request is made to move one or more development objects from a development system to one or more modules of the ERP system, such modifications to the development objects can be inconsistent with functions that are performed by other modules of the ERP system. As a result, after implementation of the transport request, the ERP system may stop operating entirely, may stop providing certain functions or may experience other problems. These deleterious effects can occur even though no damage or improper data updates have occurred in the database of the system.

When an ERP system does not operate properly, a business organization that relies on the system can be significantly damaged, perhaps to the extent that normal business operations are brought to a complete standstill. It is, accordingly, extremely important that proper operation of the ERP system be re-established as quickly as possible. Particularly when several functional aspects of an ERP system have been modified, or when multiple programmers or developers provide the modifications; it can be a difficult and time consuming process to identify the modification or modifications that caused the problem, and the state of the system prior to implementation of the modification or modifications.

It is known to replicate databases for back-up protection in case of major system disasters and for other reasons. Such replication, however, may require that the databases be periodically updated, or that entire databases be rolled-back and archived for future use.

There is, accordingly, a need for a technique that provides for rollback of an Enterprise Resource Planning system to a previous state after one or more functional modifications have been implemented in the system.

### SUMMARY OF THE INVENTION

The present invention provides a method and system for rollback of an Enterprise Resource Planning system to a previous state after one or more functional modifications have been implemented in the system.

According to an exemplary embodiment of the invention, a method for rollback of an Enterprise Resource Planning (ERP) system to a previous state after one or more functional modifications have been implemented in the system, comprises receiving functional modification data, storing previous version data of the functional modification data, implementing the functional modification data in the ERP system, receiving rollback command data, and implementing the previous version data of the functional modification data in the ERP system in place of the functional modification data.

It has been discovered that when a modification to a function of an ERP system results in some problem in the operation of the system, by returning the system to a previous state, proper operation of the system can be quickly re-established and the business organization that relies on the system can quickly return to normal business operations. Once proper operation of the system has been re-established, proper time and attention can then be given to evaluating the modification and correcting the problem. Stated another way, rather that attempting to solve the problem at the production stage, while proper operation of the ERP system may be affected; the problem can be solved at the development stage while the ERP system is operating properly and the business organization is functioning normally.

According to exemplary embodiments of the present invention, the ERP system can be an SAP R/3 system, a Peoplesoft system, a JD Edwards system or another ERP system; and the functional modification data can comprise any of a plurality of types of functional modification data. For example, in an SAP R/3 system, the functional modification data can comprise one or more development objects or a transport request function. In addition, the functional modification data can comprise data that operates, for example, in an application server or in a presentation server of an SAP R/3 system.

### BRIEF DESCRIPTION OF THE DRAWINGS

The foregoing and other advantages of the invention will become apparent upon reading the following detailed description, when taken in conjunction with the following drawings, wherein:

FIG. 1 is a block diagram that schematically illustrates a system for rollback of an Enterprise Resource Planning system to a previous state according to an exemplary embodiment of the present invention; and

FIG. 2 is a flow chart that illustrates steps of a method for rollback of an Enterprise Resource Planning system to a previous state according to another exemplary embodiment of the present invention.

### DETAILED DESCRIPTION OF EXEMPLARY EMBODIMENTS OF THE INVENTION

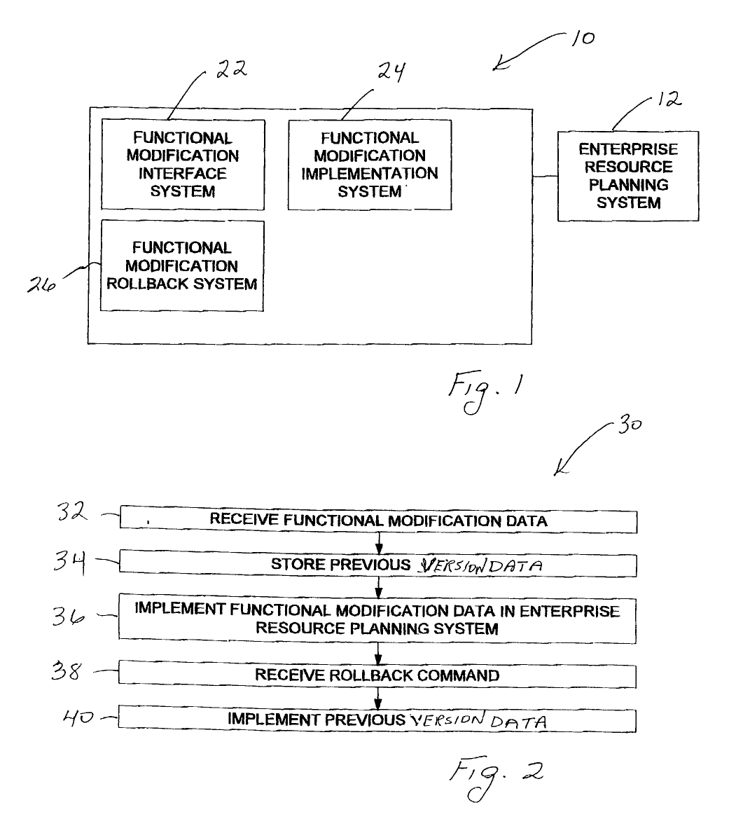

FIG. 1 is a block diagram that schematically illustrates a system for rollback of an Enterprise Resource Planning system to a previous state according to an exemplary embodiment of the present invention. The rollback system is generally designated by reference number 10, and can be implemented in hardware, software or a combination of hardware and software; and can be one or more software systems operating on a general purpose server platform. Rollback system 10 provides for rollback of an ERP system to a previous state after one or more functional modifications have been implemented in the ERP system.

In particular, when modifications are made to a function of an ERP system such as an SAP R/3 system, a Peoplesoft system or a JD Edwards system; it sometimes occurs that such modifications can be inconsistent with other functions of the system For example, in an SAP R/3 system, when a transport request is made to move one or more development objects from a development system to one or more modules of the SAP R/3 system, such modifications can be inconsistent with functions that are performed by other modules of the SAP R/3 system. As a result, after implementation of the transfer request, the SAP R/3 system may stop operating entirely, may stop providing certain functions, or may experience other problems.

When an ERP system does not operate properly, a business organization that relies on the system can be significantly damaged; and it is important that proper operation of the ERP system be re-established as quickly as possible. The rollback system 10 of FIG. 1 permits an ERP system to be returned to a previous state after one or more functional modifications have been implemented in the ERP system so that proper operation of the ERP system can be quickly re-established and a business organization that relies on the ERP system can quickly return to normal business operations. Once proper operation of the ERP system has been re-established, proper attention can be given to correcting the problem without interfering with normal business operations of the business organization.

As illustrated in FIG. 1, rollback system 10 is coupled to an Enterprise Resource Planning system 12 (the term “coupled” as used herein can comprise a physical connection, such as a copper conductor, a virtual connection, such as through memory locations of a data memory device, a logical connection, such as through logical gates of a semiconductor device, or another suitable connection). In an exemplary embodiment of the invention, rollback system 10 can also be incorporated in the ERP system 12 as will be described hereinafter.

Rollback system 10 generally includes a functional modification interface system 22, a functional modification implementation system 24 and a functional modification rollback system 26. Functional modification interface system 22 provides an interface between the rollback system 10 and the ERP system 12 so as to provide functional modifications to the ERP system, such as in a transport request or by another suitable process. Functional modification rollback system 26 stores previous version data of any functional modifications such that the functional modifications can quickly be restored to the previous state, for example, because of problems in the operation of the ERP system as a result of the functional modifications. Functional modification implementation system 24 receives the functional modifications after functional modification rollback system 26 has stored the previous version data of the functional modifications prior to implementing the functional modifications.

In an exemplary embodiment of the invention, functional modification interface system 22 can be a development object workspace for an SAP R/3 system, where both the old and new versions of functional objects are stored. After the new version of the object is stored, the functional modification implementation system 24 can receive the object by use of a transport request or other suitable process, and can provide the object to the ERP system for operation via the functional modification interface system 22.

If, following implementation of functional modifications, an operator of the ERP system discovers a problem or problems that can be traced to the implementation, functional modification rollback system 26 is used to identify the objects or other functionality that are affected, extract the previous version data of such functionality or objects, and provide such previous version data to the functional modification implementation system 24 for modification of the ERP system functionality; i.e., to return the ERP system to the previous state. In this manner, the ERP system can be quickly restored to a fully operational state without undo hardship to the business organization that relies on the ERP system.

In the exemplary embodiment described with reference to FIG. 1, rollback system 10 comprises a stand-alone system adapted to be coupled to ERP system 12. Alternatively, rollback system 10, including the functionality of the functional modification interface system 22, the functional modification implementation system 24 and the functional modification rollback system 26, can be fully incorporated in ERP system 12 without departing from the scope of the present invention. This can be provided, for example, where the ERP system provides macro functionality or other functionality.

FIG. 2 is a flowchart that illustrates steps of a method for rollback of an Enterprise Resource Planning system to a previous state after functional modifications have been implemented in the system according to another exemplary embodiment of the invention. The method is generally designated by reference number 30, and begins when functional modification data is received (step 32). In an exemplary embodiment of the invention, the functional modification data can comprise one or more development objects in a SAP R/3 system. The method then proceeds to step 34 where a previous state of the development objects or other processes are stored as previous version data of the functional modification data. For example, in addition to objects, subroutines, macros or other suitable and appropriate software can be stored.

Method 30 then proceeds to step 36 where the functional modification data is implemented in an Enterprise Resource Planning system In an exemplary embodiment of the invention, a transport request can be used to implement a development object in an SAP R/3 system, or another suitable process can be used. The method then proceeds to step 38 where a rollback command is received. In an exemplary embodiment, a rollback command can be received after the ERP system freezes, stops operating, performs an undesired operation or when another undesirable process occurs.

The method then proceeds to step 40 where the previous version data of the functional modification data is implemented, i.e., where the ERP system is returned to a previous state. In an exemplary embodiment of the invention, the previous version data can be extracted based on stored previous state data and update data; and a transport request or other suitable process can be used to implement that previous state data to replace the update data. Likewise, other suitable processes can be used.

Once the previous version data of the functional modification data has been implemented in the ERP system, the ERP system is able to resume proper operation, and the business organization that relies on the ERP system is able to resume normal business operations. Accordingly, the functional modifications that caused problems with the ERP system can be fully evaluated and appropriate corrections made in a development environment and need not be corrected in the business environment.

While what has been described herein constitute exemplary embodiments of the invention, it should be recognized that the invention can be varied in many respects without departing from the scope thereof. Because the invention can be varied in numerous ways, it should be understood that the invention should be limited only insofar as is required by the scope of the following claims.

I claim:

1. A method for rollback of an Enterprise Resource Planning (ERP) system to a previous state after one or more functional modifications have been implemented the system, comprising:
receiving functional modification data;
storing previous version data of said functional modification data;
implementing the functional modification data in the ERP system;
receiving rollback command data; and
implementing the previous version data of the functional modification data in the ERP system in place of the functional modification data.

2. The method according to claim 1, wherein said ERP system comprises one of an SAP R/3 system, a Peoplesoft system and a JD Edwards system.

3. The method according to claim 2, wherein said ERP system comprises an SAP R/3 system, and wherein the step of receiving functional modification data comprises receiving one or more development objects.

4. The method according to claim 2, wherein said ERP system comprises an SAP R/3 system, and wherein the step of implementing the functional modification data comprises using a transport request function.

5. The method according to claim 2, wherein the ERP system comprises an SAP R/3 system, and wherein the functional modification data operates in an application server of said SAP R/3 system.

6. The method according to claim 2, wherein the ERP system comprises an SAP R/3 system, and wherein the functional modification data operates in a presentation server of said SAP R/3 system.

7. A rollback system for rollback of an Enterprise Resource Planning (ERP) system to a previous state after one or more functional modifications have been implemented in the ERP system, comprising:
a functional modification implementation system for receiving functional modification data and for implementing the functional modification data in the ERP system; and
a functional modification rollback system for storing previous version data of said functional modification data and for implementing the previous version data in said ERP system in place of the functional modification data.

8. The rollback system according to claim 7, wherein said functional modification implementation system receives and implements the functional modification data after the functional modification rollback system stores said previous version data.

9. The rollback system according to claim 7, and further including a functional modification interface system that interfaces with the ERP system so as to provide said functional modification data and said previous version data to said ERP system.

10. The rollback system according to claim 9, wherein said ERP system comprises one of an SAP R/3 system, a Peoplesoft system and a JD Edwards system.

11. The rollback system according to claim 10, wherein said ERP system comprises an SAP R/3 system, and wherein said functional modification data comprises one or more development objects.

12. The rollback system according to claim 10, wherein said ERP system comprises an SAP R/3 system and wherein said functional modification implementation system is a transport request function.

13. The rollback system according to claim 10, wherein said ERP system comprises an SAP R/3 system, and wherein the functional modification data operates in an application server of said SAP R/3 system.

14. The rollback system according to claim 10, wherein said ERP system comprises an SAP R/3 system, and wherein the functional modification data operates in a presentation server of said SAP R/3 system.

15. The rollback system according to claim 7, wherein said rollback system is incorporated in said ERP system.
